(19) United States
(12) Patent Application Publication
(10) Pub. No.: US 2004/0139113 A1
(43) Pub. Date: Jul. 15, 2004

(54) Computer program for rapidly editing and visually distinguishing elements of presentation of parametric text data objects and associated files

(76) Inventor: Robert Eugene Listou, Washington, DC (US)

Correspondence Address: Robert Listou, 725 3rd Street SW, Washington, DC, 20024-3103, US

(21) Appl. No.: 10/443,364

(22) Filed: May 22, 2003

Related U.S. Application Data
(60) Provisional application No. 60/421,649, filed on Oct. 29, 2002.

(51) Int. Cl. G06F 7/00

(52) U.S. Cl. 707/104.1

(57) ABSTRACT

This invention allows a computer user permuting a displayed table of text data objects to differentiate meaningful groups of values of parametric values by selectively colorizing text so that the user perceives a plurality of patterns of differently colored text; to rapidly edit parameter values by clicking fields on the data table and selecting values from a dropdown list; and to rapidly add text data objects to the table by clicking a row on the table to display the dialog box used to create that object, and on that dialog box click a button that instantly creates a duplicate item that is then edited and saved, with the added text data object inmmediately displayed on the automatically re-sorted table. This interactive and rapid modeling of the displayed text data permits concentration of the user's attention on iteratively defined subsets of the initial display of text data objects.

This application claims the benefit of the filing date Oct. 29, 2002 of provisional application 60/421,649.

### BACKGROUND OF THE INVENTION

This invention relates to the field of data processing, particularly to computer-implemented methods for sorting and displaying tables of parametric text data objects, to visualize all possible spatial relationships between parameter values. The ability of an individual to view a rapidly displayed sequence of varying tables of selected text data objects and simultaneously view a plurality of graphic images associated with the text data objects is enabled by the invention described in U.S. Pat. No. 6,134,564. The purpose of viewing said plurality of tables is to perceive all possible groupings of parameter values, a process analogous to viewing all sides of a solid object rather than just one. The rapidity provided by that art allows the user to “model” the data table in the context of the content of his or her mind, using only three screens—Query (specify select and sort criteria), View (see the resulting data table), and Edit (revise data on the table).

Although the user can identify and save the tables that contain meaningful groups of parameter values, there is no means to distinguish such groups from the other displayed parameter values. Further, if the user believes that changing a parameter value would, when the table is re-sorted, result in an advantageous grouping, i.e. comprising a “What if” operation, the cited prior art provides a limited means for editing parameter values. Similarly, if the user believes that the table should include an additional text data object, the cited prior art does not enable rapid addition. This invention enables a user studying a data table to make changes to it at close to the speed of thought.

The prior art provides the data table user the ability to perceive simultaneously displayed images associated with the names of the text data objects named on a data table, but said art does not provide visual means for accurately controlling and cross referencing the object names and the associated images.

### BRIEF SUMMARY OF THE INVENTION

The objective of the cited prior art to enable the user of a data table to visualize and actualize differing relationships between parameter values, “model” the data as if modeling lump of moist clay, requires the fewest possible signals to the computer and the most rapid responses by the computer.

The present invention permits the user of computer-produced data table to rapidly edit “in place” the parameter values of the displayed text data objects by changing the values and/or marking them to distinguish them from other values, and immediately see the table re-sorted according to the edited data.

Another object of the present invention is permitting the user to rapidly add text data objects and associated files and immediately see them included in the automatically re-sorted table.

Another object of the invention is enhancing the user's mentation regarding a data table and simultaneous imaging of the objects themselves by visual cross references to aid associating data on the table and the object images.

The advantages of the invention are obvious in the following DESCRIPTIONS or may be learned by practice of the invention.

### BRIEF DESCRIPTION OF THE DRAWINGS

The accompanying drawings, which are incorporated in and constitute a part of this specification, illustrate particular embodiments of the invention, and together with the Detailed Description of the Invention serve to explain the principles of the invention.

FIG. 1 is an illustration of one row of a data table with the name of the text data object (101) to the right of the parameter values (104)-(107) and followed by two fields, (102) and (103), that are permanently sequenced after the name field. One field (102) contains a symbol that means the target file associated with that text data object is a graphic file available for simultaneous display, on the same or an additional monitor, and the other field (103) is explained in FIG. 3.

FIG. 2 is an illustration of another row similar to FIG. 1, with the last field (202) containing a different symbol that means the target file is an audio file available for listening.

FIG. 3 is an illustration of another row similar to those in FIG. 1 and FIG. 2 but with a different symbol in (302) showing that the target file is a graphic file, and the number in (303) is a cross reference number that is displayed adjacent to the image created when (302) is clicked. In this case the number in (303) means the file identified in (301) is the first file selected for opening.

FIG. 4 is an illustration of a data table consisting of FIGS. 1, 2, and 3 plus, below them, two rows related to additional text data objects that illustrate appearance of different data in fields (402) and (403). The blank last field (404) in the third row signifies that no target file associated with that object name is available for display or listening. The number at (403) signifies that the target file was the second file selected by the user.

FIG. 5 is an illustration of an image (501) that appears on a monitor when the user signals the computer to open a target file. It is opened when (405) is clicked or, as an alternative, clicking (405) displays a graphic image that can invoke a graphics application and that image is now clicked. Above (501) is an image (502) of the corresponding third row of the data table in FIG. 4. That image (502) is not displayed if (501) consists of the application image, but is displayed when the application is run and the target file is opened. An alternative to (502) is identical but with object name as the final column. The number at (503) is identical to (406), indicating the order of selection and is displayed when (501) is either an application image or an opened target file.

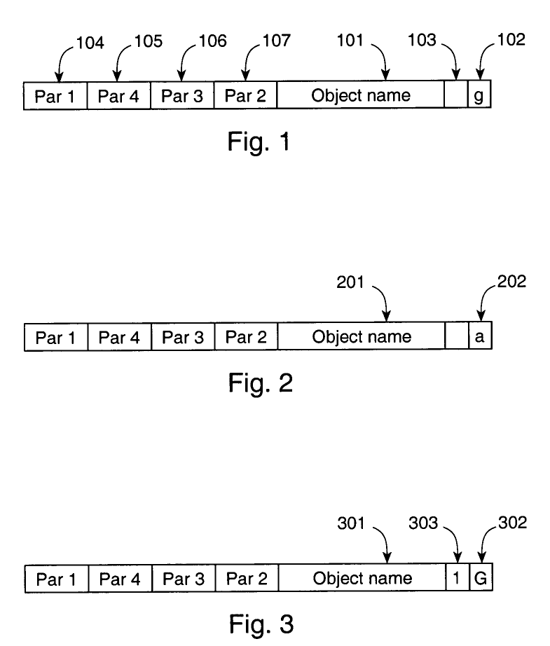

### DETAILED DESCRIPTION OF THE INVENTION

The invention is best described by explanation of using a preferred embodiment as depicted in the accompanying drawings. It will be apparent, however, to those skilled in the art that the invention described herein is not limited to the specific embodiments discussed herein, and that various modifications can be made to this invention without departing from the spirit or scope of the invention.

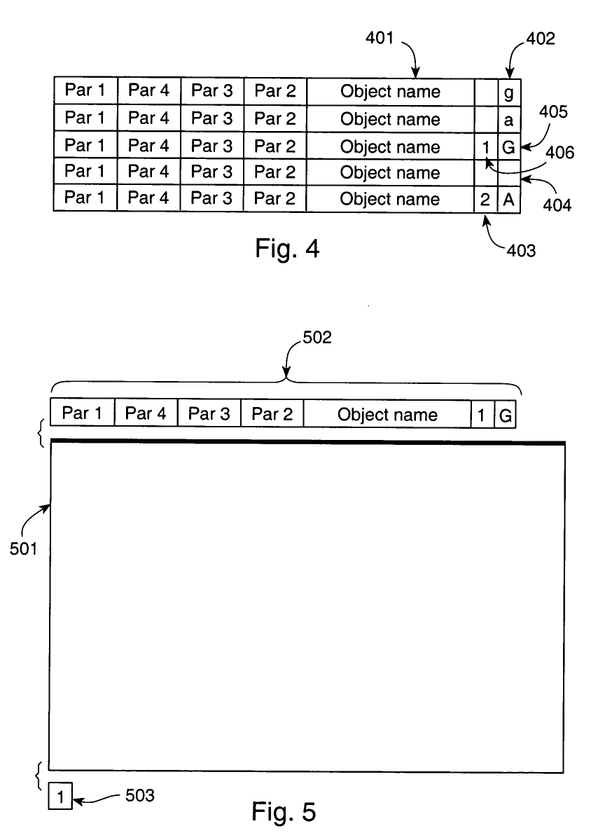

Formatting a row of a computer-produced data table with the names of the text data object (101) to the right of the parameter values (104)-(107) facilitates analysis of relationships between parameter values in the entire array on the table, and all possible permutations. The order of the parameter values (Par 1, Par 4, Par 3, and Par 2) is one of the 24 permutations of 4 parameters. Because computers sort from left to right, it is apparent that on a data table consisting of a plurality of rows, such as FIG. 4, the rows will be arranged vertically according to the values in the first and successive columns. That is a fundamental difference from a table with the object names in the first column, which provides no vertical realignment of rows when the columns are rearranged. Parameter values are subject to both horizontal and vertical realignment, thus greatly increasing the number and variety of visual relationships.

Parameter values listed first lead a viewer to the object, similar to data on an airport monitor that lead travelers to the correct gates. The same data with columns rearranged constitute useful information for persons other than travelers. Times in the first column are useful to control tower staff, and gate numbers in the first column constitute a table useful to persons who determine which gates are to be used for specific flights.

In the first case, a departing traveler examines the table to locate a single row, the row containing the data appropriate to his or her intentions, i.e. destination, flight number, and time. Assume that because of an inadvertent data entry error two different flights, scheduled to depart moments apart, are listed with the same gate number. The error would not be readily apparent to a traveler viewing the typical airport monitor. However, if the same data are imaged with the columns rearranged so gate numbers and times are the first two columns, as they could be for personnel responsible for gate assignments, the entry error would become obvious. This illustrates that different information is expressed by different permutations of the same data.

When potential conflicts or opportunities are suggested by parameter value relationships, especially when examining a plurality of permutations, the user is aided by an ability to selectively edit parameter values by changing the text and/or changing text colors to distinguish significant groups of parameter values from those around them.

Editing text data objects is accomplished by two means. When the user wishes to view the dialog box used to enter the data for a particular text data object, the object name (401) is clicked. This is useful when said dialog box contains more data than the object name and parameter values. Closing that dialog box after editing signals the computer to save the edited values and display the table automatically re-sorted. The user can also edit individual parameter values without opening the object dialog box by clicking the appropriate field, FIG. 4, which opens that field in the source, i.e. the record of that object, which is then edited.

When a double click is applied to the name of the text data object (401) a dialog box containing a choice of a small number of colors opens. The user blocks the object name and clicks a chosen color to apply it to all or a part of the text comprising the name of the text data object. Similarly, double clicking a parameter value allows the user to apply colors to the text comprising the parameter values. The color or colors distinguish those values from a background of irrelevant parameter values, enhancing the user's ability to perceive and analyze meaningful relationships between parameter values and text data objects. This is especially useful when a plurality of permutations, thus a plurality of meangful groups of parameter values, are viewed.

Conventional analysis of tables of text data objects is limited to perception of displayed parameter values and facts the user may remember about the names of the object. The present invention assumes simultaneous perception of a table of text data objects and images associated with the names of the objects, as cited in BACKGROUND OF THE INVENTION, along with visual cross references. For example, when the target file, i.e. that associated with the text data object, is a graphic file, clicking the symbol, such as (402), displays an image that is clicked to run the associated application, and the application is signaled to open the target file. In an alternative embodiment, clicking the symbol (402) invokes both the application and the stored address of the target file. That file can be an accounting report, or a photo, or a letter, or an email message, or a Web page, or any other image. The entire row, such as FIG. 3, is then displayed adjacent to the opened file (501) and a cross-reference number (303) is displayed (503) below the opened file. If clicking a symbol in the last column of FIG. 4 displays only an application image, only its cross reference number (303) is displayed adjacent to the application image. The user determines whether an individual target file is to remain open or to be closed.

Differing symbols can be used to indicate the type of file that will be opened. The resulting images are, as controlled by the user, displayed on the same monitor as the data table or on a plurality of monitors. The computer automatically generates a list of cross reference numbers in the order that the files were selected, and displays the numbers as at (503).

When the target file is an audio file, a different symbol is displayed to the right of the name of the text data, as in (202). When the user signals the computer to open that audio file, an application image that invokes an audio player is displayed on a monitor and the symbol changes, such as from “a” to “A”. When the application image is clicked, the user selects the target audio file and plays it. In an alternative embodiment, clicking the symbol (202) would invoke both the audio player and the stored address of the target audio file.

In a preferred embodiment, the data table, such as in FIG. 4, continually informs the user what associated files are available, whether they have been opened, and the cross reference numbers (406) and (403) of the target images on a monitor. The symbols in the last field (402) indicate respectively, from top to bottom, graphic file available, audio file available, graphic file available and an icon for accessing it is imaged on a monitor, no associated file, and audio file available and an icon for accessing it is imaged on a monitor.

The fourth row (404) represents the name and parameter values of a text data object that was added to the table by 4 successive and rapid operations while viewing the table: clicking the name of an object on the table to open the dialog box that displays the entire record for that object; clicking a button on that box to create and open a new record that is identical except, for example, the words “Duplicate of” preceding the object name; editing data in that box; and closing the box whereby the computer automatically re-sorts the data to recognize the added object and its parameter values and images the resulting table.

In a preferred embodiment the user can manually determine the method by which the opened files (501) associated with the names of text data objects are displayed on a monitor, for example in cascade and tile views, as well known in the state of the art. Optionally displayed adjacent to the image (501), at locations chosen by the user, are two images: the cross references to the data table, i.e. the corresponding row (502) of the data table and the number (503) identifying the selection order. Other methods include display of a plurality of single images such as FIG. 5 along with the cross references, (502) and (503).

In summary this invention allows a user studying a table of text data objects to visualize relationships between data from three sources: the displayed parameter values, images (or sounds) related to the object names and, in a greatly improved fashon because of the invention's rapid operation, the content of his or her mind. The user then then visualize revised relationships with different parameter values, and actualize them by rapidly editing parameter values. In both an initial analysis of a data table and in considering editing parameter values, the user can see, on demand, the dialog box that contains the complete record of a text data object, and concurrently see (or hear) the imaging (or playing) of the target file named on the data table.

What I claim as my invention is:

1. A method for using a computer system to rapidly edit an imaged list of text data objects, comprising:
a. signaling the computer, by clicking the name of an object, to image the complete record, consisting of the object name and associated parameter values, which can then be edited and saved;
b. signaling the computer, by clicking a field that displays the value of a parameter of a listed object, to open that field on the record, which can then be edited and saved;
c. automatic re-sorting and imaging the list when edited data are saved.

2. A method for using a computer system to selectively distinguish with a plurality of colors the object names and parameter values on an imaged table of text data objects, comprising:
a. signaling to the computer the object name or parameter value to be edited;
b. selecting from an imaged chart of colors one color to apply to text being edited;
c. saving the edited text with the selected color or colors.

3. A method for using a computer system to rapidly add text data objects to an imaged list of said objects, comprising:
a. signaling the computer, by clicking the name of an object, to image the record of that object, said record including the object name and associated parameter values,
b. signaling the computer, by clicking a button on said imaged record, to create a duplicate record;
c. editing the name and parameter values of the duplicate record;
d. signaling the computer to save the edited record and to image the list of text data objects with said list automatically resorted according to relevant parameter values.
